(19) United States
(12) Patent Application Publication
(10) Pub. No.: US 2007/0180522 A1
(43) Pub. Date: Aug. 2, 2007

(54) Security system and method including individual applications

(76) Inventor: Robert J. Bagnall, Chantilly, VA (US)

Correspondence Address: Mitchell A. Stein, Esq.;STEIN LAW, P.C., Suite 4, 24 Woodbine Avenue, Northport, NY, 11768, US

(21) Appl. No.: 11/343,737

(22) Filed: Jan. 30, 2006

(51) Int. Cl. G06F 12/14; G06F 11/00; G06F 12/16; G06F 15/18; G08B 23/00; H04L 9/32; G06F 15/173; G06F 11/30

(52) U.S. Cl. 726/22; 726/23; 726/24; 726/25; 713/188; 709/224

(57) ABSTRACT

A method and system for providing security to organizations having data and information, involving a vision specific to the organization by gathering information and determining current and future plans and needs, a scenario for protection from invasive activities including cyber-space and physical invasion, and intelligence to assist in determining protection. Also included are present and needed environmental concerns and threats, present and needed physical components, present and needed education and training for end users with access to the information, operations by examination, monitoring and detailing present and needed processes, and cyber presence including one or more computers, functions, locations, configurations, and trust relationships. Also considered are the importance of proprietary information, off-site back-ups, access-level restrictions to data, log books and preventions to minimize down-time of systems due to maintenance or attack. Also involved are collecting data, correlating the data, analyzing the data, providing reports, and evolving the method based upon information gathered. A number of different application are also provided.

### FIELD OF THE INVENTION

The present invention relates to the field of individual, corporate, company and organizational security (the words used interchangeably to identify not only an individual but a multiplicity of organizations that comprise a plurality of individuals working together and their confidential, proprietary information and need for security and protection) and more particularly to a defense system and methodology, including individual applications and/or components, for safety and security of such organizations as well as the creation and protection against the obtainment, corruption and misuse of confidential and proprietary information of such organizations.

### BACKGROUND OF THE INVENTION

It is well known in the art that maintenance and protection of company security is a critical factor to its success. The adage “business is war” has become a popular American notion that has transformed a generally moralistic economy into one in which corporate espionage (to the point of direct illegality) has become more the rule than the exception. As corporations become more competitive, so too does the need to protect confidential and proprietary information and the creation and maintenance thereof.

Likewise, under the guise of First Amendment protection, the media and many others (ostensibly including “fans”) have sought to interfere with the lives of many, whether famous or not, treading upon rights of privacy and publicity, as well as seeking access to confidential and proprietary information perhaps not for misappropriation but merely because of a claim of newsworthiness.

In any case, it is appreciated that confidential corporate information has had many forms, and the proliferation of quantity and types of media has grown disproportionately high. For example, not only must corporate intellectual property be protected, but all on-going research and development projects of complex systems to simple devices and data to employee records, are of increasing concern. Added to this fact is the existence of the Internet and the proliferation of computer equipment and access thereto, making paper almost redundant. In particular, many corporations are taking their paper-based information and scanning and storing the same in computer hard-drives for virtual access from almost any location in the world. Also, a host of information is never reduced to paper; indeed a good portion lives on computers or just in cyberspace. Increasingly, companies are also moving to “web-centric” designs, where virtually all information is kept off-site of the facilities, living on some computer provided by an Internet Service Provider (“ISP”) perhaps miles, if not countries away, all subject to “hacking” and other exposures. Lastly on this point is the old adage “garbage in—garbage out:” reliability of computer-based information provided is to some extent always suspicious.

So, from the standpoint of protecting confidential information from misappropriation, the entire landscape of protection has changed dramatically and, by all likelihood will continue to change dramatically. Not only must security include the traditional concepts that corporate personnel be protected from physical intrusions (house break-ins, abductions, etc.) and individuals be protected from the media, all by utilization of personnel and complex interactive equipment, but protection must be afforded against cyber-intervention fraud, appropriations, hacking or corruption of data and activities: the so-called “computer defense practice” or “CND” model. Additionally, steps are required to ensure that data entered is itself reliable, as many create contentions under the guise of news, when the content is mere fiction.

Traditionally, security methods were first developed by employing trained people, communication devices, and that which they saw, heard or were advised by others. Thereafter, a model of a Computer Emergency Response Team (a/k/a “CERT”) became the next field of developmental effort. CERT comprises, in general, a plurality of people and devices who communicate with one another generally under a perimeter-based thinking that, if one protects a location by protecting a certain locus around the region, then protection is complete. Of course, the concept of a perimeter is itself antiquated.

So, in short, the CERT model has become dysfunctional. The dynamic, high speed and quantity of information that can pass via the Internet, combined with a multiplicity of miniaturized devices, technical wizardry of hackers and others, and the general corporate appropriation strategy, has reduced the efficacy to almost zero of perimeter-based theories of protection, and corporations thus have become well out of touch with the severity of the situations presenting themselves continuously.

For example, in the Internet world, it takes seconds to minutes to communicate massive amounts of information and milliseconds to mass-email a virus almost anywhere on the planet. Thus, where is the “perimeter” but the entirety of the planet? The consequences of any of these cyber attacks will generally be to grind sites, like a mammoth e-commerce site, to an almost immediate halt, corrupting data and potentially creating all forms of liability from credit card thievery to loss of confidential information and even to potential criminal liability.

For example, with a cyber-based Distributed Denial of Service (a/k/a “DDoS”) attack on a company, the effect can be devastating. Indeed, even a career can be destroyed by the accidental or premature sending of an email without thinking the issue through in advance—a situation that typically would not have occurred in the day when letters were hand written or typed and mailed, rather than created and distributed instantaneously.

Well into its second decade, the CERT model now finds itself in a world to which it was never designed—a world of massive inter-connectivity and interoperability. CERT's were designed to carry the defensive load for a single enterprise or small group of networks, one that handled users and an occasional remote traveler.

In comparison, the Internet, and with it a world of communication, commerce, and connectivity which cannot be coped with effectively by a static or in-house reactive process for a prolonged period, has rendered the necessity for fundamental change in ideology, theory and action. Management and security must change to satisfy the demands newly created.

Thus, for one of ordinary skill in the art of security to fully comprehend the subject invention, it is necessary to understand the changes and evolution in CND practices and the failures to provide adequate protection, including in the world of computers and networks. For example, management has failed to do more than face the instant gratification objective. Rather than implement a large scale solution, often management looks for an inexpensive quick-fix, thinking that the company will never have a problem and this is but a cost-line item. Thus, little attention is given to proper selection or training of security personnel. Individuals have generally sought to hide from public places or where clothing that renders them inconspicuous. For individuals, none of these techniques can impact cyber-invasion. Thus, whether an individual or a corporation, the needs are substantially identical in all but the world of the media. Since the general perception is that risk is minimal, so, too, companies and individuals believe that costs should be minimal. This is short-sited. History now proves a rather high rate of security invasion, as companies and individuals are being raided and their data corrupted fairly routinely. Indeed, trojans have become almost a daily game of the malicious hacker, often discovered too late for effective action.

In terms of corporate mentality, more deficiencies are observable. For example, information sector personnel have been largely unable to impress upon management the critical needs for, and risks associated with the absence of information security. Also, rather than risk their jobs or upset their corporate affiliations, such people have been largely remiss in correctly stating the depth of investment and needs required to provide real, viable protective measures, nor have such people been complete in stating the consequences associated with a failure to take these appropriate steps.

Likewise, vendors have largely failed to place the customer's needs above their own desires for sales. In particular, vendors are primarily concerned about immediate sales (like newer, faster technology, gadgets, antivirus programs, and the like) rather than repeat business or actual customer service. The result is that both the CERT providers and the customer are lulled into a general false sense of security in mis-perceiving that if they buy “state of the art” headsets, cameras, a firewall, fancy recording equipment, or the like, they have the latest and greatest protection and are invasion proof. Reading the “fine print” attending such devices often shows that companies really have no rights should an invasion occur.

Additionally, customers lack a real recognition of the cost/benefit analysis associated with strong digital security. According to Gardner Group Estimates, 80% of all network attacks and intrusions are performed by insiders. Little attention is given to compromise avoidance by complete checking and verification of those with access, as well as password enforcement and other systems administration, to avoid penetrations. Rather, companies look at the cost of security as but a direct line item expense. Many companies believe that they are not susceptible having acquired hardware and software (without much regard to their generally ill or untrained staff), and hence do not perform the analysis required. A single intrusion can cost the entire company. Prevention against invasions or intrusions is thus probably of the highest order priority, not to be treated just as a line item expense without concern for the liability associated therewith.

Likewise, exceptional security staff are also difficult to acquire and quantify. No common standard exists in the industry as the recognized method for training or certifying cyber-security professionals. As a result, not enough certified, experienced, well educated security staff exists—so companies “steal” experienced personnel for each other. The consequence is that the costs (salaries and the like) are increased, yet while paying more, companies do not increase the quality of their total security simply by acquiring an expensive staff member, while simultaneously creating a shortage of such personnel at other organizations (e.g., from whom such personnel are stolen or by whom such personnel are no longer affordable).

Where such shortages exist, the lack of training and experience of those present causes a lack of perceived value in such staff. Companies therefore perceive more value in hiring more consultants, who cost more yet do not have the environmental knowledge or experience of regular staff (nor the many other inventive elements present herein). In the worst case scenarios, smaller companies do not even hire security staff because quality staff is either at a shortage or price prohibitive.

Such shortages have even further implications. Where a company cannot obtain an experienced cyber-security professional, then it cannot adequately train any of its staff members. Where such professionals do provide training, then their personnel become more valuable which, in turn, typically creates the opportunity to go to the highest bidder—the so-called “theft” of the personnel. As a result, in the scenarios that predicate the within invention, companies are forced to perceive the value of rigorous security training as a difficult risk to manage, as the result is often forfeiture and the need to train another group.

It should be further appreciated that the CERT model was created to protect networks of computers, people, file cabinets and the like when they were static, closed systems with limited scope within a defined perimeter. The CERT model was created based upon technology that essentially preceded the Internet, and thus was never designed to support active defense measures but rather to be reactive to an actual, recognizable physical intrusion into the perimeter, not a cyber trojan discovered typically after invasion and the damage has already occurred.

Also heretofore known in the art is the signature file anti-virus defense, which has become almost a de facto standard for companies, basically because of the heretofore lack of viable alternatives. Yet, the advent of four primary factors has proven that reliance solely on signature-based AV defenses, even in multiple layers by differing vendor products, is no longer a viable solution.

First the popularity of easy-to-use compiler-based programs has greatly simplified the process of creating viruses for those seeking mischief. Second, the rise of Melissa and other easy-to-code, easy-to-alter virus families as an attack tool has made regular signature file updating a logistical nightmare, particularly for large organizations. Indeed, updating occurs typically only after the virus has hit, ultimately to prevent proliferation, but too late for those already hit. Third, such programs are typically computer specific, and thus each must be updated. Lastly, the advent of a stronger, more effective heuristic behavior-based, perimeter anti-virus defense layer render multi-layered AV protection far more viable than exclusive use of signature file based systems. Behavior-based products require updates normally only for product version revisions because such products are based upon a behavior pattern of a family type for the virus, rather than the specific signature of a file. Yet there are few of such systems, which provide but a supplemental perimeter protection in between regular signature file AV updates on servers.

Lastly, the weakest link in the chain remains a human one. The single greatest example of this is the failure of organizations to implement and enforce the most basic building blocks of information security: policy and access. An enterprise can be “state of the art” in equipment, but if the users are not aware of and adhere to basic policy and access control, the network becomes a welcome mat for intrusion rather than a barrier against the same.

It is thus an objective of the instant invention to provide a method and system that involves a full complement of activities to increase the likelihood of protection of companies against invasion and corruption—the obvious needs of security—and to overcome the wealth of deficiencies indicated hereinabove.

It is still a further objective of the instant invention to provide a method and system that overcomes the problems associated with the CERT/perimeter-based technology and defense based upon a whole environmental approach to security, in recognition that there is nothing smaller than a global perimeter in light of the Internet, considering such devices as USB storage devices, wireless network cards, bluetooth® and other related technologies.

It is yet a still further objective of the instant invention to provide protection for individuals' rights of privacy and publicity, preventing intrusions by media and other sources that, while not necessarily posing an immediate security risk (save for driving), nonetheless are deserving of attention and monitoring for avoidance.

It is still a yet further objective of the instant invention to provide at least one individual application and/or product for additional facilitation of the security system and method herein.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

It therefore would be desirable, and is an advantage of the present invention, to provide a method and system for providing security to organizations having data and information, involving a vision specific to the organization by gathering information and determining current and future plans and needs, a scenario for protection from invasive activities including cyber-space and physical invasion, and intelligence to assist in determining protection. Also included are present and needed environmental concerns and threats, present and needed physical components, present and needed education and training for end users with access to the information, operations by examination, monitoring and detailing present and needed processes, and cyber presence including one or more computers, functions, locations, configurations, and trust relationships. Also considered are the importance of proprietary information, off-site back-ups, access-level restrictions to data, log books and preventions to minimize down-time of systems due to maintenance or attack. Also involved are collecting data, correlating the data, analyzing the data, providing reports, and evolving the method based upon information gathered.

A plurality of individual applications can be utilized in the subject invention to add greater advantage to the security and method described hereinbelow.

In particular, an online privacy and security awareness program powered by computer-available multimedia (like Flash® or similar programs) provides on-line and interactive training and education to support individual and corporate comprehension and use of the inventive method and system.

Also, an organization or its users have the ability to a multiphasic process, involving the following phases: (1) a questionnaire, completed by the user, comprising a series of questions and location for responses concerning the computer system utilized by that user, followed by a preferably remote server that runs diagnoses system of such computer system via, e.g., running remote diagnoses systems resources, usage, and the like; (2) running of a number of repair programs preferably by a remote server including, by way of example, scan disk, fixes for bad clusters and sectors, elimination of scrap and unused files, Internet files, cookies, scans for viruses, and general disk and/or system clean-up; (3) recommendations, preferably provided by the remote server, concerning performance and security solutions from a list of preferred software vendors, and where such list is unavailable, via a remoter server providing a list of recommended solutions from other vendors. In this manner, tunupsonline.com 72 recommends a performance tune-up preferably every 90-180 days based upon usage. This number can be adjusted as time passes and a usage profile is constructed concerning the organization.

A threat intelligence database for profiling nation states, groups, technologies, events, and actors is also shown.

Also shown is a chronological interactive timeline with configurable views for presenting historical, anniversary, and event data for computer crime and pop culture, linked to a library combining information, alphanumeric, image, source attribution and statistical corroboration, searchable based upon one or more of discipline relationships, recurring predefined analyses and random search criteria.

Also shown in FIG. 6 is a darwin based open-source security kernel implementation for mission-specific security applications.

Also shown is a source of ope-ed pieces about cyber-security and the industry designed to promote industry consideration and discussion.

Also shown is a machine-level code application protection, predefined by the organization during installation, such that if the host program is downloaded by an unauthorized user to the user's computer having a storage media, this system sends an information file directly to the host describing the unauthorized user via one or more indicia, including, for example, system identification, registry information and configuration, followed by modification (by, for example, erasure or degradation) of the unauthorized user's receiving computer's storage media.

Card hardware is also shown as one of the plurality of available applications. In this instance, an instant alias is provided by the card to a user for providing multiple layers of security to mask the user's true identity from discovery and to protect the system accessed by the user from an attack. Instant alias is enabled in this card capable of hosting a plurality (e.g., up to 10) alias profiles, together with personal and computer protections of sufficient megabyte quantity to provide efficacy (e.g., over 200 MB). The card is used because it can be utilized in a multiplicity of devices, from PC's to NC's, laptops, notebooks, kiosks, and certain palm devices for provision of mobility and security.

An information retriever is presented which is a Java-based intelligence agent personal data retrieval tool. In particular, the retriever operates in the background on any computer attached to the inventive method and system, utilizing a multi-layered query engine which can auto-dump or store unrelated information from multiple levels and await until retrieved by the user, while archiving the data for later use. The retriever can also email the data to a specified account, helpful to traveling users who can remotely enter requests. The retriever also includes an automatic update portion for seeking user pre-defined websites for updating such sites at a pre-determined frequency. When updating, the computer being updated will meld the update, batch the update list into a single pop-up window to be shown on the screen immediately or remain in the background, or send an email to a pre-determine address indicating that updating has occurred. Likewise, for those users involved in stock pricing and the like, the retriever can be programmed to provide stock data at predetermined intervals, e.g., every hour, half hour, quarter hour or the like, and even provide a banner to act upon a change in circumstances of the underlying stock in virtual real-time. Other features of the retriever can be determined by one of ordinary skill in the art, armed with the inventive information provided herein without deviating from the letter, spirit or claims of the subject invention.

Availability, security and performance (“ASP”) is provided via a rack-mountable OS X sensor that consistently monitors essential network nodes and pipes of the instant method and system, for availability, security and performance. ASP is placed in the organization's network where the network receives health and welfare “pings,” user usage statics, process executions, CPU utilization, policy enforcement and specific security state indicators (including, e.g., syslogd or SNMP traps) to proactively facilitate network operations and security. ASP utilizes localized perimeter security agents placed on individual computers in the organization in combination with its own parsing and utilization engines to prevent incident events, and mitigate those that are prevent, on the fly in real time.

An online security monitoring service is also presenting comprising a software component protecting individuals and organizations from cyber-interlopers via a 24/7/365 centralized monitoring center for current status, including network load, usage and pre-determined acceptable use for security protection. This service comprises three main process steps: (1) an access network posture via telephone, on-line, and in-person security experts to review the current status of service and protection; (2) an implement service via agents, reporting and response through such security experts to establish solution to problems encountered in step (1); and (3) a monitor, access, alert and defend capability wherein such security experts provide persistent vigilance over not just the entire organizational network, but each of its components.

Also shown is a system that is predominantly digital for providing security to an organization that has both data and information stored in a multiplicity of locations, whether paper-based or digitally stored. The system includes determining means for determining the organization's present and needed environmental concerns and threats and for providing satisfaction of such needs, determining means for determining the organization's present and needed physical components for security and providing satisfaction of such needs, determining means for determining the organization's present and needed education and training for end users with access to the data or information and for providing satisfaction of such needs, determining means for determining operations by examination, monitoring and detailing present and needed processes and for providing satisfaction of such needs, and determining means for determining and providing cyber presence including one or more computers, functions, locations, configurations, and trust relationships.

The system has at least one or more of the following components:

(a) the importance to the organization of proprietary information;

(b) whether critical data is backed up off-site;

(c) access-level restrictions to data, ranked in accordance both with the data and the “need to know” of those with access, as well as log books and the like showing dates and times of access and data accessed;

(d) determining whether preventions are in place to avoid or minimize down-time of systems due to maintenance or attack; and

(e) determining the existence of other vulnerabilities or risks not easily recognized.

The system also possesses one or more of the following steps:
(a) collecting data concerning the organization;
(b) correlating the data collected by enabling filtration of security-relevant from irrelevant data;
(c) analyzing the data and information collected;
(d) providing at least one report on the current and future security status of the organization; and
(e) evolving the system in accordance with performance, data and information after the digital processes are employed.

The system further has at least one of the following components:
(a) an active defense division for 24/7/365 security provision;
(b) a research and development division for creation of greater security devices and processes;
(c) a knowledge division for the provision of a knowledge base as well as at least training, awareness, education, and policy;
(d) an analysis component for managing the information and the knowledge base;
(e) an information warfare warehouse with analysis as the core component, including storage and analysis of network traffic, assessment of potential vulnerabilities and penetrations, and alerts to the active defense division when anomalies are discovered;
(f) a report containing a focused coverage of a prior period of cyber and other events and a discussion of emerging trends in the industry and organization including, without limitation, tips, education and opinion designed to promote thought in the organization and provoke industry-leading discussion;
(g) a cyber-intelligence well output of the system, including a library of electronic documents covering, among other things, cyber capability and threats;
(h) a 2-minute offense comprising a daily report digest of internal dynamics for the active defense division to be able to provide rapid response;
(i) a distributed security/warfare component for specific security functions for offensive use;
(j) a malware analysis and rating criteria comprising a tabular system for rating and analyzing malware;
(k) a standard for incident measurement and exposure for networks for rating vulnerability exposure comprises an array of components larger than the malware analysis;
(l) a methodology for incident prevention and response for evolutionary change in the system; and
(m) a security protection factor for provision of a measurable number for demonstrating the current state of a client's security.

The foregoing additional applications are also provided in the system.

Thus it is a feature of the instant invention to provide a heretofore unforeseen but complete security package for organizations and individuals that evolves to suit the needs of the organization and involves a plurality of differing components to render the features complete.

### BRIEF DESCRIPTION OF THE DRAWINGS

The features, aspects, and advantages of the present invention will become better understood with regard to the following description, appended claims, and accompanying drawings where:

FIG. 1 sets forth a flowchart of the basic elements of the security method, process and system, in accordance with a preferred embodiment of the subject invention;

FIG. 2 sets forth a badge-styled assembly drawing of the fundamental elements of the method and system, in accordance with a preferred embodiment of the subject invention;

FIG. 3 sets forth a flowchart of the digital defense method portion of the preferred embodiment of the subject invention;

FIG. 4 sets forth a flowchart of the digital defense process of the preferred embodiment of the subject invention;

FIG. 5 sets forth the system overview of the preferred embodiment of the subject invention; and

FIG. 6 sets forth a plurality of individual applications and/or operations, one or more of which are utilized in a preferred embodiment of the instant invention.

### DETAILED DESCRIPTION OF THE PREFERRED EMBODIMENTS

It should be noted that in the detailed description which follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

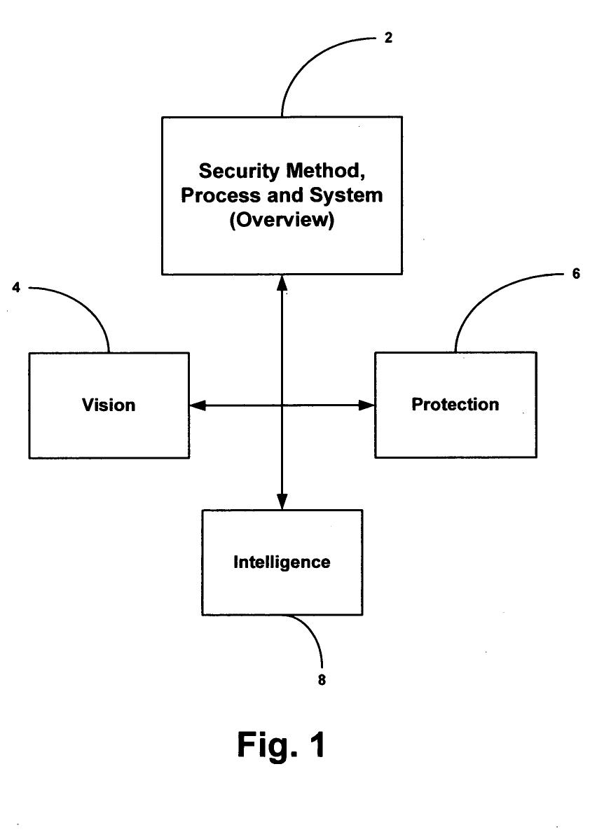

FIG. 1 shows a general overview of the security method and system of preferred embodiment 2 of the subject invention which is directed at taking a “holistic” view of the entire security and protection of a company utilizing the whole environment as its essential thrust with full recognition that the perimeter is now worldwide as a result of the Internet.

In greater particularity as shown in FIG. 1, system 2 considers three major elements. First, system 2 possesses vision 4 which generally requires a deeper understanding of the organization and the direction in which it intends to proceed, in order that vision 4 of the system 2 be created specifically for the organization in a manner to satisfy not just its current but its future needs in an evolving sense. Thus, unlike systems heretofore known, each method and system is crafted to the specific needs of the organization in issue.

Likewise, key element protection 6, as also shown in FIG. 1 is the protection scenario under system 2, as explained in greater detail hereinbelow, involving a plurality of stages after vision 4 is completed. Lastly, intelligence 8, as the name implies, is the acquisition of intelligence concerning the organization in issue from its many different forms also as explained hereinbelow and as understood by one of ordinary skill in the industry armed with the description, drawings and claims set forth herein. Intelligence 8 involves intelligence from all locations and sources, whether verbal (or documentary), oral (by word of mouth), computer-based, observational (as in viewing locations), personnel (interviews and background checks, and the like), all aimed at creating intelligence 8 as a network under vision 4 for protection 6, as part of system 2.

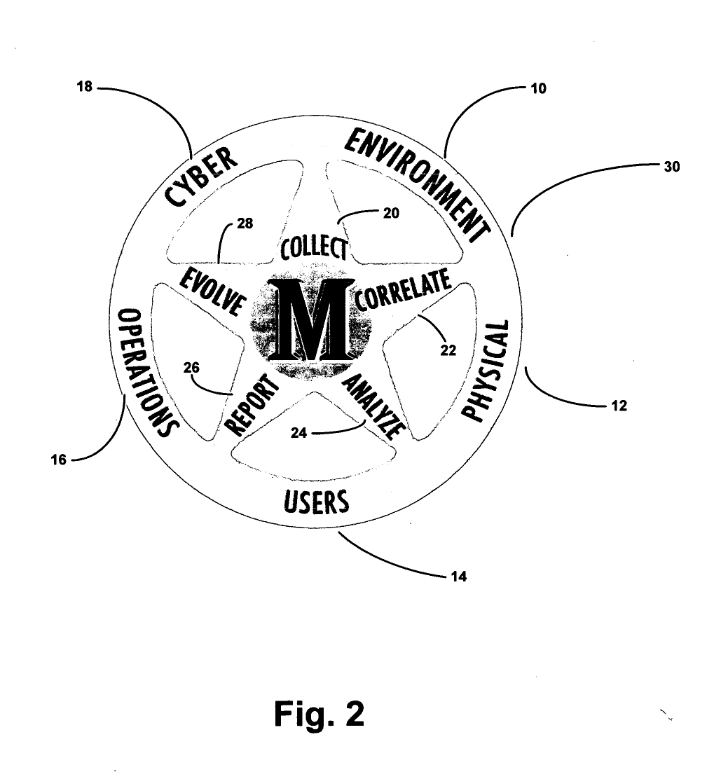

As shown in FIG. 2, the essential components of system 2 relate especially well to a wheel or badge view 30 as each element indicates. The “M” in the middle represents not only a reference to the inventor's trademark “Maverick” but the core vision as a functional element to serve as the hub for the entire system and process 2.

In particular, environment 10 recognizes that examining and protecting against environmental threats is a most basic element in the instant security method and system 2. Environmental threats as shown by environment 10 include, without limitation, non-digital forces and their impact including, by way of example, the impact of weather, dust, or other external natural threats compared against the proximity of an organization's assets and susceptibility of those assets to environmental threats. Likewise, location of data is of environmental concern whether kept on site, off site, or in cyber space. If on site, then clean room conditions are of concern. If off site, then backups are of concern. Indeed, backing up the data both on site and off site are key relevant concerns as part of environment 10 and the analysis of the organization's current condition. Consider, for example, a single data center located along the gulf coast with no backup system in place could represent an environmental threat especially in light of hurricanes. Likewise, if data is maintained on a PDA which is thereafter lost (or dropped in a river, or the like), all the data, including potentially hundreds of contacts, would be lost.

Environment 10 in FIG. 2 is a unique aspect of the instant invention in the sense that it considers all environmental implications both weather-wise and otherwise. For example, an organization located in the desert possesses differing environmental issues than one in, for example, a jungle location. By way of non-limiting example, the former may have greater visibility against physical threats while the latter has greater protection against wind and sand storms. These considerations are all accounted for by the instant method and system 2.

Also as shown in FIG. 2, physical component 12 is a critical element of the system and method. In particular, physical security involves protection of the company, whether from intentional or unintentional intrusions. Factors effecting physical component 12 include inventory and location of assets, the level of protection (like gates and weapons), the perception of the members of the organization and its adversaries. Indeed, in the world of trade secrets, the steps taken by companies for physical protection (as well as others, discussed hereinbelow) are critical legal predicates for maintenance of legal protection of trade secrets. Fences, barbed wire, gate houses, gate keepers, security staff, dogs, accidents, riots or other actions and the like are all elements considered in physical component 12. Thus, consideration of physical component 12 involves factors that affect the potency of physical threats, the level of protection given to assets and the perceived value of those assets, for example, must also be examined as part of the physical defense effort.

Further to FIG. 2, education and training of end users 14 is another critical element of the inventive system and method herein. End-users have traditionally been the weakest link in the security chain for many of the reasons heretofore expressed. Yet, these potential liabilities, under the current inventive method and system, are turned into assets. Background checks, psychological evaluations, education, awareness, and enforcement of rules and regulations will reduce if not eliminate user-caused errors. For example, a strong internal monitoring effort, one that includes user-behavior profiling and analysis, is yet another critical element in the success of the instant method and system. This factor protects the company not just from others, but, as well, from itself. Thus, threat awareness and education of users, backed up by a solid enforcement effort, make users accountable and user-induced error largely preventable. A strong internal monitoring efforst, one that include behavior analysis of users, is another important piece of user step 14.

Operations 4 as shown in FIG. 2 is next in the critical method and system herein. Once the foundation of environment 10 and physical 12 are assessed, operations 4 must be examined, monitored, details of process and methods understood evaluated and often modified, and the organization's culture and activities from habit on down, must be understood, codified, and modeled. The concept is not to change the method in which the organization succeeds at business, but to prevent the losses associated with an invasion should the same occur, through vigilant maintenance. Questions raised include, by way of example: (a) the importance to the organization of proprietary information; (b) whether critical data is backed up off-site; (c) access-level restrictions to data, ranked in accordance both with the data and the “need to know” of those with access, as well as log books and the like showing dates and times of access and data accessed; (d) are preventions in place to avoid or minimize down-time of systems due to maintenance or attack; and (e) are there other vulnerabilities or risks not easily recognized. Recognition of operations 4 is thus a critical element to the successful implementation of the method and system herein.

Much has already been discussed herein concerning cyber 18 as shown in FIG. 2. Heretofore, security consultants typically perceive that a cyber portion as the first piece of the puzzle. Under the instant invention, however, cyber 18 is a critical last past piece of the equation. Without examining and protecting the other critical elements (environment 10, physical 12, users 14, operations 16) cyber 18 would be missing these critical elements and be blind to them. Consider, for example, a cyber consideration that did not consider environment 10 of the organization and the threats associated with physical 2 and the existence of human induced threats, users 14 and their skills and profiles, or operations 16 involving the habits and goals of the organization in issue. The cyber system would be largely like flying blindfolded. Cyber 18 also includes not only digital devices, but knowledge of their location, function, configuration, trust relationships, and related items. Thus, to present cyber 18 and consider all of its ramifications requires the other heretofore described predicates as well.

Cyber 18 and the security associated therewith includes not only security devices, device location, monitoring, and device mapping, but less common factors such as system configuration and patching, device discovery and detailed configuration and expectations, trust relationships with other organizations that provide cyber services and offices. Likewise, cyber 18 does not just include the typical over-the-counter anti-virus tools, but review of each piece of code to assess, relatively, the hostility and threats associated therewith.

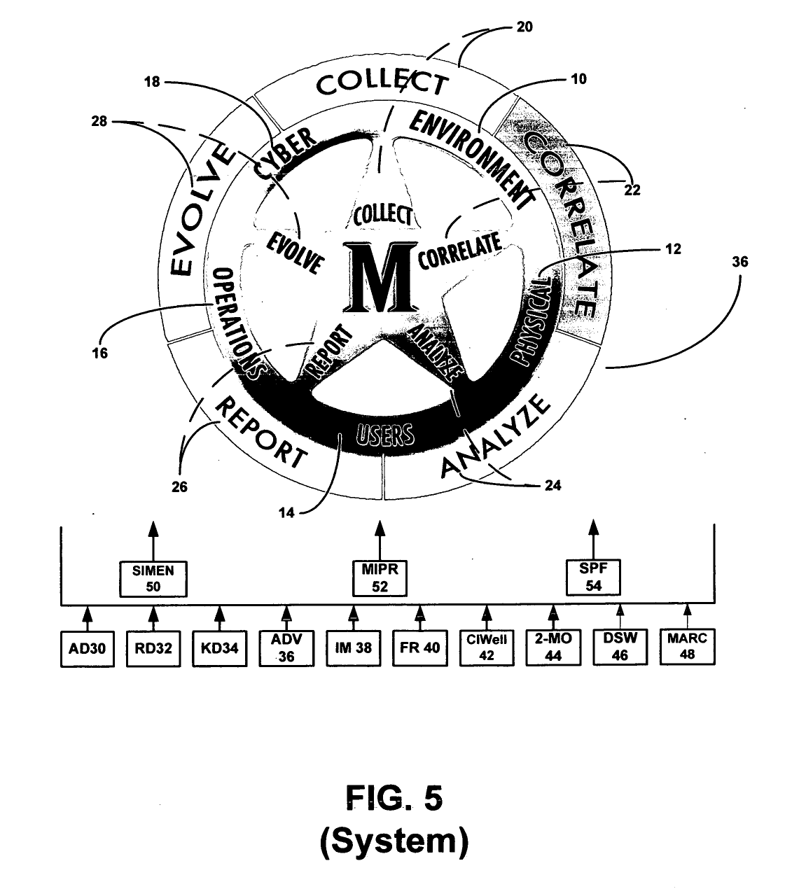

In order to satisfy steps 10, 12, 14, 16 and 18 of the method and system of the instant invention, various steps must be taken repeatedly, as shown in the inner portion of FIG. 2, as well as the outer ring of FIG. 5. In particular, before environment 10 can be determined and protected, it is important that the organization be fully understood not only by capturing data, but capturing the right kinds of data through collect 20. Such data includes all of the necessary predicates described in connection with environment 10, physical 12, users 14, operations 16 and cyber 18.

Raw data collected via collect 20 is not itself sufficient. Such data needs to be correlated via correlate step 22, as shown in FIG. 2. The largest problem with data collection ir reduce the volume or quantity; it is necessary to correlate already extant knowledge about the state of security data for the organization, security settings, and experience existing security devices, as well as the limitations that are inherent in such devices. Correlate 22 enables filtration of noise including false signals and chatter from actual data necessary, to enable the efficacy of the method and system of the instant invention.

As shown further in FIG. 2, the next important step in the inventive method and system involves analyze step 24. In order to be effective of proactive and mitigative cyber-defense efforts, data must be transformed from raw data collected in step 20 to intelligence. Intelligence, created in analyze step 24, enable a combination of facts and information that permits a decision-maker to take some action as a result, in defense of the environment. Only analysis directed from within the context of a specific organization's environment, can there be proper provision of environmental intelligence and proactive assistance in defending the organization. The key is to establish defense to threats, rather than to react after the threat has already hit.

Also as shown in FIG. 2, report function 28 is critical to success of the instant security method and system and is most and effect and least appreciated when it is silent. Only regular reporting, tracking of security strength and evolution using environmental and security metrics, proves both the value and the effectiveness of security. Reporting allows an organization to have true vision into its security posture, to track the progress and evolution of the security effort, and to assist in efficacy.

No security method or system continues to function properly if it does not evolve with an organization as the organization changes. Hence, as further shown in FIG. 2, evolve step 28 is a critical element of the success of the security method or system. Thus, as the parameters change for the organization, so too must the security method and system of the instant invention evolve via step 28. Additionally, laws change, and Federal and State compliance issues along with them (whether SEC, Blue Sky, Homeland Security, common law trade secret or other intellectual property protection, employees' rights and employers' liabilities and the like). Here, evolution can be as minor as changing security settings on a device or system, to something as revolutionary change to the culture of use of digital technologies by a person or organization to meet compliance or be more secure. All such elements are considering and incorporated in evolve step 28.

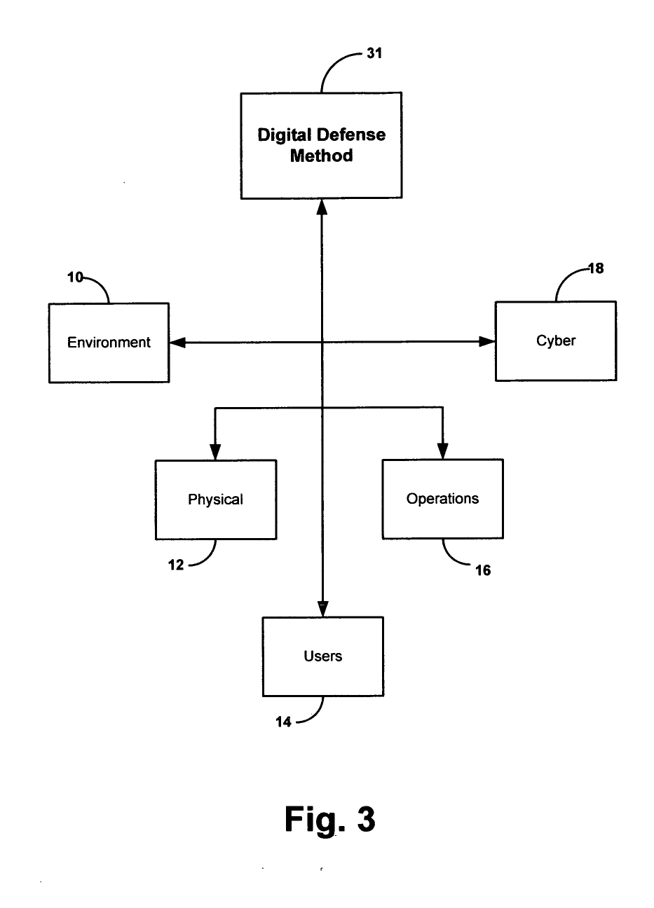

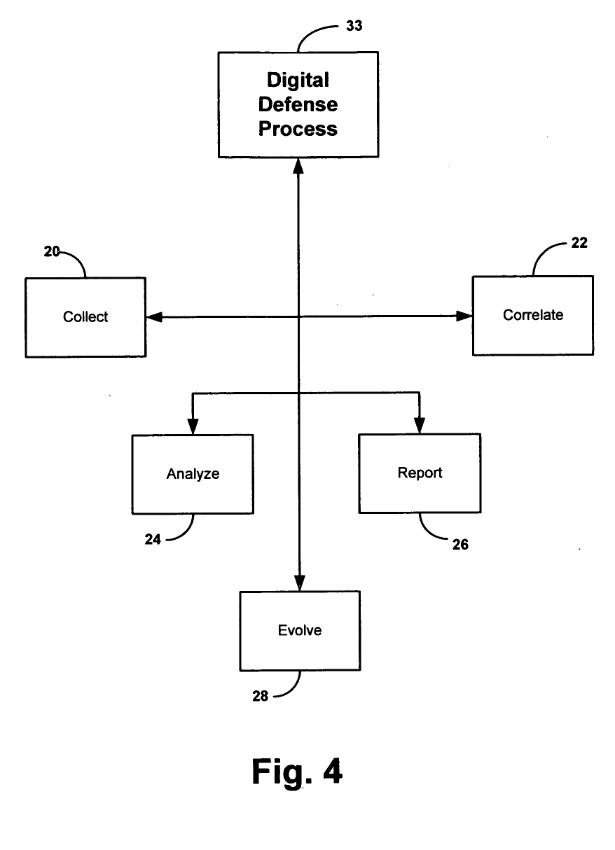

Thus, the instant system and process and be divided into two segments, as shown in FIGS. 3 and 4. In particular, as shown in FIG. 3, Digital Defense Method 31 involves the outer circle elements of FIG. 2, names environment 10, physical 12, users 14, operations 16, and cyber 18, as described hereinabove.

Likewise, the Digital Defense Process 33 accounts for the information and data gathered via the elements of FIG. 3 and the innermost elements shown in FIG. 2, namely collect 20, analyze 24, evolve 28, report 26, and correlate 22.

FIG. 5 shows the entirety of the system, wherein the steps of collect 20, correlate 22, analyze 24, report 26 and evolve 28 are shown repeated inasmuch as these steps are continuously repeated after data is gathered via the Digital Defense Method 31 (FIG. 3). For example, analyze step 24 includes an active defense division 30 (“AD”) which acts as a “war room” where a staff of up to 30 personnel (depending on the situation) are involved 24/7/365 to defend, evalute and evolve up to 10 customer networks. AD is the one division where the moment-to-moment dynamic defense measure are consistently tested, measured and evolved.

AD personnel thus perform a wide array of functions, including responsibility for direct security-related liaison with customers, random penetration testing and risk assessments, and monitoring network defenses. AD personnel will also implement the scripts and proprietary tool kits developed hereunder and specific to each organization, in concert with the organization and the information gathered as shown in the FIG's. Evolve 28 also originates from such AD personnel.

Likewise, the system shown in FIG. 5 involves an R&D component 32 responsible for coordinating with all other divisions to create and post security devices and personnel, as well as informational releases through major reporting agencies such as CERT/CC and the National Infrastructure Protection Center. R&D Security Advisories cover a wide variety of topics, to include hostile cod, to exploits, potential and real vulnerabilities, new protective measures, scripts and code, and new vendor product evaluations.

Collect 20 as shown in FIG. 5 of the system also includes a knowledge division (“KD”) 34 which is the “heart” of training, awareness, education and InfoSec policy in accordance with the method and system of the instant invention. The division is responsible for internal training as well as policy and procedure development and implementation and efforts to determine awareness in advance of a threat or intrusive attack.

The FIG. 5 system also involves an analysis component (“ADV”) 36 responsible for managing the informational backbone and general knowledge base of the inventive method and system. Analysis component 36 also integrates with knowledge division (“KD”) 34. Information Warfare Warehouse (“IWW”) 38, shown as emanating from correlation step 22, is more than a mere database, but is an information resource with the analyst in mind. Thus warehouse 38 stores data, miniming data, providing automatic link and relational analysis (typically based upon the organization's in-house scripting), and generate of security reporting via report 26 upon pre-established protocols.

Thus, warehouse 28 acts as more than just a repository of data, but also includes storage and analysis of network traffic, assessment of potential vulnerabilities and penetrations, and provides alerts to AD division 30 when anomalies are discovered. Warehouse 28 is also designed with searchable schemata, including key work searches as well as custom scripting and bot technologies to both mine open source customer network data as well as scour its own information store for analyst-driven search queries. Searches can be programmed also to run at predetermined intervals, and anomalies reported if and when discovered, thereby decreasing the time-intensive aspects of human involvement.

Flailcon report (“FR”) 40, as shown in FIG. 5 is also a key element of the system of the current invention, which provides organizations with a focused covereage of the previous week's cyber events as well as a discussion of emerging trends in the industry. Report 40 thus includes tips, education and opinion designed to promote thought by the organization and provoke industry-leading discussion.

The Cyber-Intelligence Well (“CI-Well”) 42 is an output of the system, and includes a library of electronic documents covering several open-source security periodicals designed to be utilized both as a service enhancement component for the organization and available as a stand-alone subscription for others who may not acquire the entirety of the method and system described herein. CI-Well 42 includes: (a) a focus on the ability of a given country to project cyber capability and threats posed, as well governmental policies, laws, doctrines and related impacts; (b) a report on individuals and groups that possess abilities to cause cyber-based trouble including hackers, organized crime and trans-nationals, as well as prior exploits, modus operandi, memberships, and whether any have country support or protection; and (c) a report of current security and future expectations for organizations, including historical information.

A “2-Minute Offense” (a/k/a “2-MO”) 44 is a daily report digest of internal dynamics related to cyber-security issues, education and commentary designed to provide the AD a basic understanding of the current status of the Internet and risks, and the impact upon competitive advantage, service enhancements and operational improvements.

The Distributed Security/Warfare component (“DSW”) 46, shown in FIG. 5 as emanating from cyber 18, modularizes and integrates specific security functions into specialized single-purpose technologies residing in various areas and forms about the enterprise providing redundant, comprehensive oversight of network security operations. Component 46 also includes an offensive aspect to defend assets during potential violations both actively and passively, to prevent enterprise/organizational exposure.

Also included in FIG. 5 is the Malware Analysis and Rating Criteria (“MARC”) 48 which comprises a unique tabular system for rating and analyzing malware (e.g., software that is either dysfunctional or dangerous). MARC 48 provides both an initial (generic) rating to assess the impact based upon a formula-metric series of factors as well as the control for local security teams to apply context to the initial rating. MARC 48 is designed to be specific to the organization.

The Standard for Incident Measurement and Exposure for Networks (“SIMEN”) 50 rates vulnerability exposure in a manner similar to MARC 49, except that it involves a larger formula comprising a wider array of facts to ensure accuracy. Vulnerabilities involve a far more expansive set of criteria for the evaluation of impact and exposure.

The Methodology for Incident Prevention and Response (“MIPR”) 52 creates an evolutionary change in the manner in which cyber-security operations are implemented, performed and delivered in that it drives a series of operational capabilities about a central core.

FIG. 5 shows the Security Protection Factor (“SPR”) 54 which provides a measurable number for demonstrating the current state of a client's digital security posture, with a higher number indicating a higher level of protection, and thus creates a simple mechanism for those who may not wish to be involved in the detail to be able to determine the level of protection and, antithetically, the current level of risk.

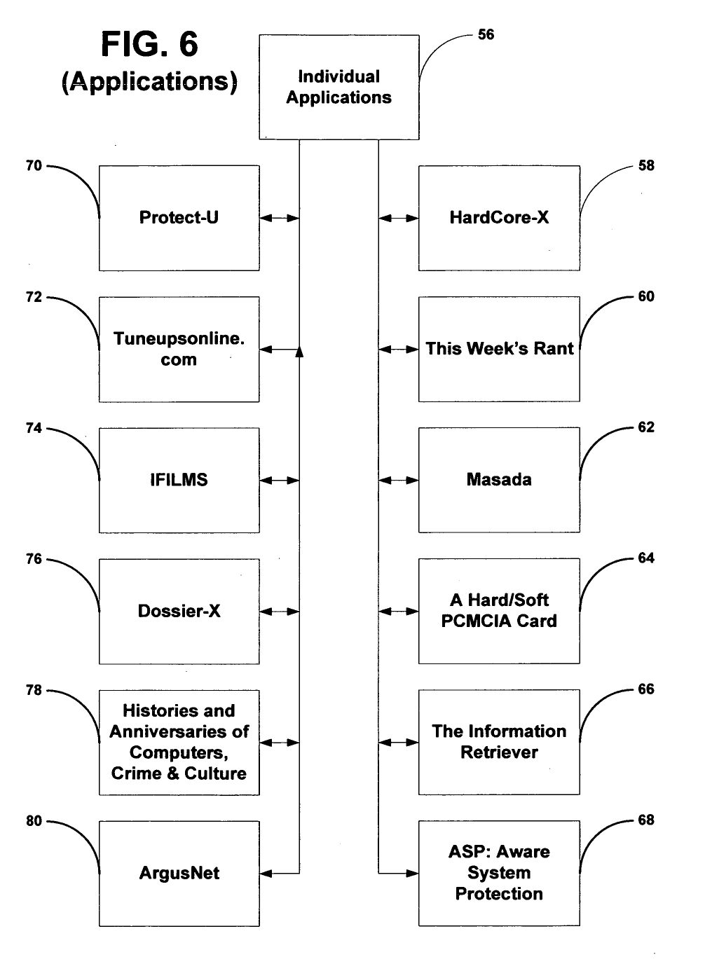

Lastly, FIG. 6 shows a plurality of individual applications 56, one or more can be utilized in the subject invention to add greater advantage to the security and method described hereinbelow.

In particular, as shown in FIG. 6, Protect-U 70 is shown which comprises an online privacy and security awareness program powered by computer-available multimedia (like Flash® or similar programs) via I-Films 74, to provide on-line and interactive training and education to support individual and corporate comprehension and use of the inventive method and system.

As shown in FIG. 6, tuneupsonline.com 72 is also shown, which permits an organization or its users the ability to a multiphasic process, involving the following phases: (1) a questionnaire, completed by the user, comprising a series of questions and location for responses concerning the computer system utilized by that user, followed by a preferably remote server that runs diagnoses system of such computer system via, e.g., running remote diagnoses systems resources, usage, and the like; (2) running of a number of repair programs preferably by a remote server including, by way of example, scan disk, fixes for bad clusters and sectors, elimination of scrap and unused files, Internet files, cookies, scans for viruses, and general disk and/or system clean-up; (3) recommendations, preferably provided by the remote server, concerning performance and security solutions from a list of preferred software vendors, and where such list is unavailable, via a remoter server providing a list of recommended solutions from other vendors. In this manner, tunupsonline.com 72 recommends a performance tune-up preferably every 90-180 days based upon usage. This number can be adjusted as time passes and a usage profile is constructed concerning the organization.

Dossier-X 76, also shown in FIG. 6, provides a threat intelligence database for profiling nation states, groups, technologies, events, and actors.

Also as shown in FIG. 6 is Histories and Anniversaries of Computers, Crime & Culture 78 which provides a chronological interactive timeline with configurable views for presenting historical, anniversary, and event data for computer crime and pop culture, linked to a library combining information, alphanumeric, image, source attribution and statistical corroboration, searchable based upon one or more of discipline relationships, recurring predefined analyses and random search criteria.

Hardcore-X 58, also as shown in FIG. 6 is darwin based open-source security kernel implementation for mission-specific security applications.

This week's rank 60, also as shown in FIG. 6 is a source of op-ed pieces about cyber-security and the industry designed to promote industry consideration and discussion.

Also as shown in FIG. 6, masada 62 is shown which provides a machine-level code application protection, predefined by the organization during installation, such that if the host program is downloaded by an unauthorized user to the user's computer having a storage media, masada 62 sends an information file directly to the host describing the unauthorized user via one or more indicia, including, for example, system identification, registry information and configuration, followed by modification (by, for example, erasure or degradation) of the unauthorized user's receiving computer's storage media.

Hard/Soft PCMCIA card 64 is also shown in FIG. 6 as one of the plurality of available applications. In this instance, an instant alias is provided by card 64 to a user for providing multiple layers of security to mask the user's true identity from discovery and to protect the system accessed by the user from an attack. Instant alias is enabled in card 64 capable of hosting a plurality (e.g., up to 10) alias profiles, together with personal and computer protections of sufficient megabyte quantity to provide efficacy (e.g., over 200 MB). The card is used because it can be utilized in a multiplicity of devices, from PC's to NC's, laptops, notebooks, kiosks, and certain palm devices for provision of mobility and security.

FIG. 6 also shows information retriever 66, sometimes named “K-9” like the police-canine unit, which is a Java-based intelligence agent personal data retrieval tool. In particular, retriever 66 operates in the background on any computer attached to the inventive method and system, utilizing a multi-layered query engine which can auto-dump or store unrelated information from multiple levels and await until retrieved by the user, while archiving the data for later use. Retriever 66 can also email the result set to a specified account, helpful to traveling users who can remotely enter requests. Retriever 66 also includes an automatic update portion for seeking user pre-defined websites for updating such sites at a pre-determined frequency. When updating, the computer being updated will meld the update, batch the update list into a single pop-up window to be shown on the screen immediately or remain in the background, or send an email to a pre-determined address indicating that updating has occurred. Likewise, for those users involved in stock pricing and the like, retriever 66 can be programmed to provide stock data at predetermined intervals, e.g., every hour, half hour, quarter hour or the like, and even provide a banner to act upon a change in circumstances of the underlying stock in virtual real-time. Other features of retriever 66 can be determined by one of ordinary skill in the art, armed with the inventive information provided herein without deviating from the letter, spirit or claims of the subject invention.

ASP 68, an acronym for aware system protection provides a rack-mountable OS X sensor that consistently monitors essential network nodes and pipes of the instant method and system, for availability, security and performance. ASP 68 is placed in the organization's network where the network receives health and welfare “pings,” user usage statics, process executions, CPU utilization, policy enforcement and specific security state indicators (including, e.g., syslogd or SNMP traps) to proactively facilitate network operations and security. Asp 68 utilizes localized perimeter security agents placed on individual computers in the organization in combination with its own parsing and utilization engines to prevent incident events, and mitigate those that are prevent, on the fly in real time.

Lastly, FIG. 6 shows ArgusNet 80 which is an online security monitoring service comprising a software component protecting individuals and organizations from cyber-interlopers via a 24/7/365 centralized monitoring center for current status, including network load, usage and pre-determined acceptable use for security protection. ArgusNet 80 comprises three main process steps: (1) an access network posture via telephone, on-line, and in-person security experts to review the current status of service and protection; (2) an implement service via agents, reporting and response through such security experts to establish solution to problems encountered in step (1); and (3) a monitor, access, alert and defend capability wherein such security experts provide persistent vigilance over not just the entire organizational network, but each of its components.

Although the preferred embodiment of this invention has been shown and described, it should be understood that various modifications and rearrangements of the parts may be resorted to without departing from the scope of the invention as disclosed and claimed herein.

I claim:

1. A method for providing security to organizations having data and information, comprising:
(a) determining a vision specific to the organization by gathering information from the organization and determining its current and future plans and needs from such information;
(b) determining a scenario for protection of such information and for the organization from invasive activities including cyber-space and physical invasion;
(c) gathering intelligence from the corporation to assist in determining the scenario for protection; and
(d) implementing the scenario.

2. The method of claim 1, wherein the steps (a) through (c) involve a digital defense method and a digital defense process.

3. The method of claim 2, wherein the digital defense method comprises at least one and preferably all of the following steps:
(a) determining the organization's present and needed environmental concerns and threats;
(b) determining the organization's present and needed physical components;
(c) determining the organization's present and needed education and training for end users with access to the information;
(d) after determining 3(a) and 3(b), determining operations by examination, monitoring and detailing present and needed processes; and
(e) after 3(a) through 3(d) have been completed, determining cyber presence, needs and plans including one or more computers, functions, locations, configurations, and trust relationships.

4. The method of claim 3 wherein step (c) comprises at least considering one of the following issues and preferably considering them all:
(a) the importance to the organization of proprietary information;
(b) whether critical data is backed up off-site;
(c) access-level restrictions to data, ranked in accordance both with the data and the “need to know” of those with access, as well as log books and the like showing dates and times of access and data accessed;
(d) determining whether preventions are in place to avoid or minimize down-time of systems due to maintenance or attack; and
(e) determining the existence of other vulnerabilities or risks not easily recognized.

5. The method of claim 2, wherein the digital defense process comprises at least one and preferably all of the following steps:
(a) collecting data concerning the organization;
(b) correlating the data collected by enabling filtration of security-relevant from irrelevant data;
(c) analyzing the data and information collected;
(d) providing at least one report on the current and future security status of the organization; and
(e) evolving the method in accordance with performance, data and information after the digital processes are employed.

6. The method of claim 1, wherein the organization has at least one user with a computer and the organization has a computer system involving at least one computer, comprising at least one of the following applications:
(a) an online privacy and security awareness program powered by computer-available multimedia (like Flash® or similar programs);
(b) an on-line and interactive training and education to support individual and corporate comprehension;
(c) a multiphasic process, involving the following phases: (1) a questionnaire, completed by a user, comprising a series of questions and location for responses concerning the computer system utilized by that user, followed by a preferably remote server that runs diagnoses system of such computer system via, e.g., running remote diagnoses systems resources, usage, and the like; (2) running of a number of repair programs preferably by a remote server including, by way of example, scan disk, fixes for bad clusters and sectors, elimination of scrap and unused files, Internet files, cookies, scans for viruses, and general disk and/or system clean-up; and (3) recommendations, preferably provided by the remote server, concerning performance and security solutions from a list of preferred software vendors, and where such list is unavailable, via a remoter server providing a list of recommended solutions from other vendors; wherein the multiphasic process recommends and performs a performance tune-up at predetermined intervals;
(d) a threat intelligence database for profiling nation states, groups, technologies, events, and actors;
(e) a chronological interactive timeline with configurable views for presenting historical, anniversary, and event data for computer crime and pop culture, linked to a library combining information, alphanumeric, image, source attribution and statistical corroboration, searchable based upon one or more of discipline relationships, recurring predefined analyses and random search criteria;
(f) a darwin based open-source security kernel implementation for mission-specific security applications;
(g) a source of op-ed pieces about cyber-security and the industry designed to promote industry consideration and discussion;
(h) machine-level code application protection, predefined by the organization, such that if a host program on a computer is downloaded by an unauthorized user to the user's computer having a storage media, said code application sends an information file directly to the host describing the unauthorized user via one or more indicia, including, for example, system identification, registry information and configuration, followed by modification (by, for example, erasure or degradation) of the unauthorized user's receiving computer's storage media;
(i) hardware means for providing an instant alia for the at least one user for providing multiple layers of security to mask that user's true identity from discovery and to protect the system accessed by the user from an attack;
(j) information retriever means intelligence agent for personal data retrieval, operating in the background on any computer attached to the system, utilizing a multi-layered query engine to auto-dump and archive date from multiple levels and await until retrieved by the user, via direction from the user,
(k) aware system protection means via a rack-mountable OS X sensor that consistently monitors essential network nodes and pipes of the instant method and system, for availability, security and performance; and
(l) an online security monitoring means comprising a software component protecting individuals and organizations from cyber-interlopers via a 24/7/365 centralized monitoring center for current status, including network load, usage and pre-determined acceptable use for security protection.

7. The method of claim 6, wherein element (j) further comprises an automatic update portion for seeking user pre-defined websites for updating such sites at a pre-determined frequency, by melding the update, and then presenting the same to the user on the user's computer.

8. The method of claim 7, wherein in step (j) further comprises presentation selected from the group consisting of batching the update list into a single pop-up window to be shown on the screen immediately; placing the update list in the background of the computer for later access, or sending an email to a predetermined address indicating that updating has occurred.

9. The method of claim 7, wherein in step (j) and subject to preselection by the user, users involved in stock pricing and the like, are provided stock data at predetermined intervals and a banner to act upon the data presented.

10. The method of claim 6, in which element (k) further comprises in the organization's system reception of health and welfare “pings,” user usage statics, process executions, CPU utilization, policy enforcement and specific security state indicators to proactively facilitate operations and security in essentially real-time.

11. The method of claim 6, in which step (l) further comprises three main process steps: (1) access to the system via telephone, on-line, and in-person security experts to review the current status of service and protection; (2) an implementation service via agents, reporting and response through such security experts to establish solution to problems encountered in step (1); and (3) a monitor, access, alert and defend method wherein such security experts provide persistent vigilance over not just the entire organizational network, but each of its components.

12. A predominantly digital system for providing security to an organization having data and information stored in a multiplicity of locations that include paper and digital storage, comprising:
(a) determining means for determining the organization's present and needed environmental concerns and threats and for providing satisfaction of such needs;
(b) determining means for determining the organization's present and needed physical components for security and providing satisfaction of such needs;
(c) determining means for determining the organization's present and needed education and training for end users with access to the data or information and for providing satisfaction of such needs;
(d) after determining 12(a) and 12(b), determining means for determining operations by examination, monitoring and detailing present and needed processes and for providing satisfaction of such needs; and
(e) after 12(a) through 12(d) have been completed, determining means for determining and providing cyber presence including one or more computers, functions, locations, configurations, and trust relationships.

13. The system of claim 12 wherein step (c) comprises at least considering one of the following issues and preferably considering them all:
(a) the importance to the organization of proprietary information;
(b) whether critical data is backed up off-site;
(c) access-level restrictions to data, ranked in accordance both with the data and the “need to know” of those with access, as well as log books and the like showing dates and times of access and data accessed;
(d) determining whether preventions are in place to avoid or minimize down-time of systems due to maintenance or attack; and
(e) determining the existence of other vulnerabilities or risks not easily recognized.

14. The system of claim 12, wherein the digital defense process comprises at least one and preferably all of the following steps:
(a) collecting data concerning the organization;
(b) correlating the data collected by enabling filtration of security-relevant from irrelevant data;
(c) analyzing the data and information collected;
(d) providing at least one report on the current and future security status of the organization; and
(e) evolving the system in accordance with performance, data and information after the digital processes are employed.

15. The system of claim 14, further comprising at least one of the following components:
(a) an active defense division for 24/7/365 security provision;
(b) a research and development component for creation of greater security devices and processes;
(c) a knowledge component for the provision of a knowledge base as well as at least training, awareness, education, and policy;
(d) an analysis component for managing the information and the knowledge base;
(e) an information warfare warehouse with analysis as the core component, including storage and analysis of network traffic, assessment of potential vulnerabilities and penetrations, and alerts to the active defense division when anomalies are discovered;
(f) a report containing a focused coverage of a prior period of cyber and other events and a discussion of emerging trends in the industry and organization including, without limitation, tips, education and opinion designed to promote thought in the organization and provoke industry-leading discussion;
(g) a cyber-intelligence well output of the system, including a library of electronic documents covering, among other things, cyber capability and threats;
(h) a 2-minute offense comprising a daily report digest of internal dynamics for the active defense division to be able to provide rapid response;
(i) a distributed security/warfare component for specific security functions for offensive use;
(j) a malware analysis and rating criteria comprising a tabular system for rating and analyzing malware;
(k) a standard for incident measurement and exposure for networks for rating vulnerability exposure comprises an array of components larger than the malware analysis;
(l) a methodology for incident prevention and response for evolutionary change in the system; and
(m) a security protection factor for provision of a measurable number for demonstrating the current state of a client's security.

16. The system of claim 12, wherein the organization has at least one user with a computer and the organization has a computer system involving at least one computer, comprising at least one of the following applications:
(a) an online privacy and security awareness program powered by computer-available multimedia (like Flash® or similar programs);
(b) an on-line and interactive training and education to support individual and corporate comprehension;
(c) a multiphasic process, involving the following phases: (1) a questionnaire, completed by a user, comprising a series of questions and location for responses concerning the computer system utilized by that user, followed by a preferably remote server that runs diagnoses system of such computer system via, e.g., running remote diagnoses systems resources, usage, and the like; (2) running of a number of repair programs preferably by a remote server including, by way of example, scan disk, fixes for bad clusters and sectors, elimination of scrap and unused files, Internet files, cookies, scans for viruses, and general disk and/or system clean-up; and (3) recommendations, preferably provided by the remote server, concerning performance and security solutions from a list of preferred software vendors, and where such list is unavailable, via a remoter server providing a list of recommended solutions from other vendors; wherein the multiphasic process recommends and performs a performance tune-up at predetermined intervals;
(d) a threat intelligence database for profiling nation states, groups, technologies, events, and actors;
(e) a chronological interactive timeline with configurable views for presenting historical, anniversary, and event data for computer crime and pop culture, linked to a library combining information, alphanumeric, image, source attribution and statistical corroboration, searchable based upon one or more of discipline relationships, recurring predefined analyses and random search criteria;
(f) a darwin based open-source security kernel implementation for mission-specific security applications;
(g) a source of op-ed pieces about cyber-security and the industry designed to promote industry consideration and discussion;
(h) machine-level code application protection, predefined by the organization, such that if a host program on a computer is downloaded by an unauthorized user to the user's computer having a storage media, said code application sends an information file directly to the host describing the unauthorized user via one or more indicia, including, for example, system identification, registry information and configuration, followed by modification (by, for example, erasure or degradation) of the unauthorized user's receiving computer's storage media;
(i) hardware means for providing an instant alia for the at least one user for providing multiple layers of security to mask that user's true identity from discovery and to protect the system accessed by the user from an attack;
(j) information retriever means intelligence agent for personal data retrieval, operating in the background on any computer attached to the system, utilizing a multi-layered query engine to auto-dump and archive date from multiple levels and await until retrieved by the user, via direction from the user,
(k) availability, security and performance means via a rack-mountable OS X sensor that consistently monitors essential network nodes and pipes of the instant method and system, for availability, security and performance; and
(l) an online security monitoring means comprising a software component protecting individuals and organizations from cyber-interlopers via a 24/7/365 centralized monitoring center for current status, including network load, usage and pre-determined acceptable use for security protection.

13. The system of claim 12, wherein element (j) further comprises an automatic update portion for seeking user pre-defined websites for updating such sites at a pre-determined frequency, by melding the update, and then presenting the same to the user on the user's computer.

14. The system of claim 13, wherein step (j) further comprises presentation selected from the group consisting of batching the update list into a single pop-up window to be shown on the screen immediately; placing the update list in the background of the computer for later access, or sending an email to a pre-determined address indicating that updating has occurred.

15. The system of claim 13, wherein in step (j) and subject to preselection by the user, users involved in stock pricing and the like, are provided stock data at predetermined intervals and a banner to act upon the data presented.

16. The system of claim 12, in which element (k) further comprises in the organization's system reception of health and welfare “pings,” user usage statics, process executions, CPU utilization, policy enforcement and specific security state indicators to proactively facilitate operations and security in essentially real-time.

17. The system of claim 12, in which step (l) further comprises three main process steps: (1) access to the system via telephone, on-line, and in-person security experts to review the current status of service and protection; (2) an implementation service via agents, reporting and response through such security experts to establish solution to problems encountered in step (1); and (3) a monitor, access, alert and defend method wherein such security experts provide persistent vigilance over not just the entire organizational network, but each of its components.
